(19) United States
(12) Patent Application Publication
(10) Pub. No.: US 2004/0008967 A1
(43) Pub. Date: Jan. 15, 2004

(54) Method and apparatus of optical components having improved optical properties

(76) Inventors: Ching Chu, Sunnyvale, CA (US); Nickolai Belov, Cupertino, CA (US); Sebastiaan in't Hout, San Jose, CA (US); Vladimir Vaganov, Los Catos, CA (US)

Correspondence Address: Dr. David Harrar II, Mega Sense, Inc., 1215 Bordeaux Drive, Sunnyvale, CA, 94089, US

(21) Appl. No.: 10/618,484

(22) Filed: Jul. 11, 2003

Related U.S. Application Data
(60) Provisional application No. 60/396,485, filed on Jul. 15, 2002.

(51) Int. Cl. G02B 6/00; G02B 6/32

(52) U.S. Cl. 385/140; 385/33

(57) ABSTRACT

A method and apparatus for a VOA with improved wavelength-dependent optical losses is provided. The primary elements of this improved VOA are a package, a movable structure with a reflecting surface, and a collimator. The collimator is comprised of various optical components including a ferrule holding at least two waveguides and a lens. Selecting a ferrule and a lens such that the plane containing the end of the ferrule and the ends of the waveguides is not parallel to the facing end of the lens, it is possible to determine positions and axial orientations of the ferrule with respect to the lens which result in minimal wavelength-dependent optical losses. By geometrically configuring the optical components of the collimator in this way, and subsequently positioning and axially orienting the collimator and movable structure to minimize wavelength-dependent losses, a VOA with minimal wavelength-dependent optical losses can be constructed.

### RELATED APPLICATIONS

This application claims priority of earlier filed U.S. Provisional Application number 60/396,485 filed on Jul. 15, 2002, and fully incorporates the material therein.

### BACKGROUND OF THE INVENTION

The present invention provides a method and apparatus of combined optical components having improved optical characteristics, reduced wavelength dependent loss, reduced polarization dependent loss, and improved manufacturing and production characteristics.

### FIELD OF THE INVENTION

An illustrative application of the present invention is a Variable Optical Attenuator (VOA) having a plurality of optical waveguides, a collimator comprising a medium for aligning the optical waveguides such as a ferrule and a focusing and directing medium such as a lens, and a reflective medium such as a mirror. The optical waveguides generally comprise optical fibers or planar optical waveguides. One of the plurality of waveguides serves as an optical input or transmitter, and another of the plurality of waveguides serves as an optical output or receiver. The focusing device of the optical medium is generally a lens, focusing and directing the beam from the input waveguide, where the beam reflects off the reflective medium, returning through the focusing device, received by and exiting through the output waveguide.

Examining prior art devices, it can be generalized that the beam transition from optical waveguides to optical medium typically takes place through a void or transition medium, with both the planar faces of the optical waveguides and opposite planar face of the focusing device angled at a set offset from the normal axis of beam propagation. The planar faces are angled in parallel at a specific angle (typically approximately ninety-eight degrees measured counter-clockwise from the normal axis of beam propagation) to minimize back reflection in the system. The alignment and positioning of the ferrule, lens, and reflective medium is of particular concern to the optical characteristics of such devices. Minor axial, angular, and lateral misalignments greatly reduce production yields as well as adherence of conforming to optical specifications such as wavelength dependent loss (WDL) and polarization dependent loss (PDL).

Typically, this type of VOA devices may be utilized for either narrowband or broadband applications. Wavelength dependent losses are obviously of concern in broadband applications. Polarization dependent losses are of concern in both types of applications. It would be beneficial if a method and apparatus were available to minimize WDL, PDL and both WDL and PDL concurrently in an optical device comprised of multiple optical components. It would further be beneficial if a method and apparatus were available to improve manufacturing and production of such devices.

It has been found and will be described by the present invention that unexpected beneficial properties are achieved with respect to WDL and PDL of optical devices comprised of multiple optical components through altering the angle of the optical medium opposite the waveguides of an optical device, thus the opposing planar faces of the waveguides and optical medium are not parallel. Further, the present invention provides for controllable manipulation of at least one optical sub-component.

Wavelength dependent loss (WDL) and polarization dependent loss (PDL) are of concern in the design of optical devices such as Variable Optical Attenuators. It is desirable to reduce or limit WDL and PDL in such devices. Such characteristics also apply to alternate optical devices such as N×N optical switches, add/drop optical switches, tunable taps, and combinations of such devices. In accordance to the present invention WDL and PDL are minimized in such devices through altering the angle of the planar face of the optical medium opposite the waveguides. Optical beams are further conditioned due to controlled manipulation of the orientation of at least one optical component of the optical device or system.

Research and experimentation has shown that maintaining an approximate angle of ninety-eight degrees from the normal axis of beam propagation on the planar face of optical waveguides in devices such as VOA's minimizes back reflection. It is thus beneficial to maintain this configuration. Research and experimentation has also shown that altering the angle of the planar face of the optical medium opposite the waveguides in devices such as VOA's does not substantially influence losses associated with back reflection. Further, the unexpected result has been found that altering the angle of the planar face of the optical medium can beneficially alter the WDL and PDL characteristics of the combined optical sub-components. Certain configurations have also proved more beneficial in minimizing or eliminating WDL and PDL individually, as well as both WDL and PDL in conjunction.

Although prior art devices are such that WDL properties of the devices are mentioned, reduction, let alone minimization, of WDL has not been addressed. There is, therefore, a long-felt need in the art of optical components, for example variable optical attenuators, for optical components having improved optical properties such as minimal WDL.

### SUMMARY OF THE INVENTION

The objects and advantages of the proposed invention are secured by a Variable Optical Attenuator (VOA) comprising a package, a movable structure with a reflecting surface, and a collimator, with the collimator further comprising at least two waveguides, a ferrule holding at least a portion of the waveguides, a lens, and a housing to which the ferrule and lens are mounted.

In certain preferred embodiments of the present invention the ferrule and lens are subtantially cylindrical in shape, though it will be obvious to one skilled in the art that the shape of these optical components may be more general. The waveguides are held by the ferrule close to the central axis of the ferrule with the ends of the waveguides sharing the same plane as the end of the ferrule. In order to decrease the deleterious effects of back reflection from the lens during operation of the VOA, this plane shared by the ends of the waveguides and the end of the ferrule is generally not perpendicular to the central axis of the ferrule; instead it is oriented at an angle θ₁ with respect to this central axis. The end of the lens facing the end of the ferrule—and hence ends of the waveguides—is assumed to be planar and oriented at an angle θ₂ with respect to the optical axis of the lens. In order to decrease WDL the plane of the ends of the waveguides and of the ferrule is not parallel to the facing end of the lens. For certain axial orientations of the ferrule and waveguide ends with respect to the lens, minimal WDL is realized.

In a preferred embodiment of the present invention the angle θ₂=90 that the planar end of the lens facing the ends of the waveguides and ferrule is perpendicular to the optical axis of the lens. For such an embodiment axial rotation of the lens will clearly have no effect on WDL since the orientation of the end of the lens with respect to the optical axis is independent of axial orientation. Prior to mounting the ferrule to the housing of the collimator, the ferrule is rotated axially while light is passed through an input waveguide, is collimated by and passes through the lens, impinges on a temporary movable structure with a reflecting surface, is reflected back through the lens, and is focused by the lens at least partially into an output waveguide; and at each axial position WDL is measured. This temporary movable structure may be different from the movable structure to be used in the VOA. In this way an axial orientation of the ferrule with respect to the lens is determined, this orientation resulting in a collimator providing minimal WDL. Once this orientation is determined, the lens and ferrule are mounted to the collimator housing in this position and axial orientation resulting in minimal WDL. The collimator is now “WDL-optimized”. It remains only to mount the movable structure to be used in the VOA and the collimator to a package. In so doing, the position and axial orientation of the collimator and movable structure relative to one another must be adjusted while passing light through the device so as to determine the position and orientation providing minimal WDL. Once this is determined the collimator and movable structure are mounted to the package and a VOA with minimal WDL is obtained.

In another preferred embodiment the ferrule and lens are such that there exists an axial orientation of the two components such that ends of the waveguides and ferrule are parallel to the facing end of the lens. In this embodiment the components would be positioned and axially oriented with respect to one another so that the ends of the waveguides and ferrule are no longer parallel to the facing end of the lens. In still another preferred embodiment one of the two components would be rotated 180 degrees from the axial orientation of planarity prior to being fixed in the collimator housing. The VOA assembly would then proceed as outlined above.

In still other preferred embodiments the angle θ₁ of the plane containing the ends of the waveguides and ferrule with respect to the central axis of the ferrule and the angle θ₂ of the facing end of the lens are distinct and not equal to 90 degrees. One of these two optical components is mounted to the housing, and the other component is rotated axially in relation to the mounted component and light is inserted into the input waveguide, passes through the lens, is reflected by a movable structure with a reflective surface back through the lens and at least partially into the output waveguide, and WDL is measured at each axial orientation until an orientation resulting in minimum WDL is determined. Subsequently the second optical component is mounted to the housing such that the axial orientation of the lens and ferrule provides minimal WDL. Assembly of a VOA with minimal WDL then proceeds as outlined above.

It will be recognized by one skilled in the art that optical components other than those referenced in certain preferred embodiments can also be used to realize the objects of the current invention. The preferred embodiments should therefore not be viewed as limiting with regard to the scope and application of the present invention.

### BRIEF DESCRIPTION OF THE DRAWINGS

The features of the invention may be better understood with reference to the accompanying specification and drawings depicting various preferred embodiments in which:

FIG. 1 is a schematic illustration of a typical VOA as implemented in the prior art.

FIG. 2 is a diagram illustrating a VOA device in accordance with the preferred embodiment of the present invention where θ₂=180°−θ₁.

FIG. 3 is a graph illustrating the WDL and PDL performance of the VOA device of FIG. 2 at increasing attenuation through 360° rotation of the collimator with respect to the tilting axis of the reflective surface.

FIG. 4 is a diagram illustrating a VOA device in accordance with the preferred embodiment of the present invention where θ₂=90.

FIG. 5 is a graph illustrating the WDL and PDL performance of the VOA device of FIG. 4 at increasing attenuation through 360° rotation of the collimator with respect to the tilting axis of the reflective surface.

FIG. 6 is a diagram illustrating a VOA device in accordance with the preferred embodiment of the present invention where θ₂<θ₁, or more generally where θ₂≠θ₁.

FIG. 7 is a graph illustrating the WDL and PDL performance of the VOA device of FIG. 6 at increasing attenuation through 360°rotation of the collimator with respect to the tilting axis of the reflective surface.

FIG. 8 is a diagram illustrating a VOA device in accordance with the preferred embodiment of the present invention having a GRIN lens.

FIG. 9 is a graph illustrating the WDL and PDL performance of the VOA device of FIG. 8 at increasing attenuation through 360°rotation of the collimator with respect to the tilting axis of the reflective surface.

### DETAILED DESCRIPTION OF THE PRESENT INVENTION

Particular embodiments of the present invention are illustrated with respect to Variable Optical Attenuators in the following figures and supporting graphs. An illustrative example of a VOA of the prior art is also presented for reference. The illustration of the present invention using VOA's is not intended to strictly limit application to such devices, but merely offered as a convenient example.

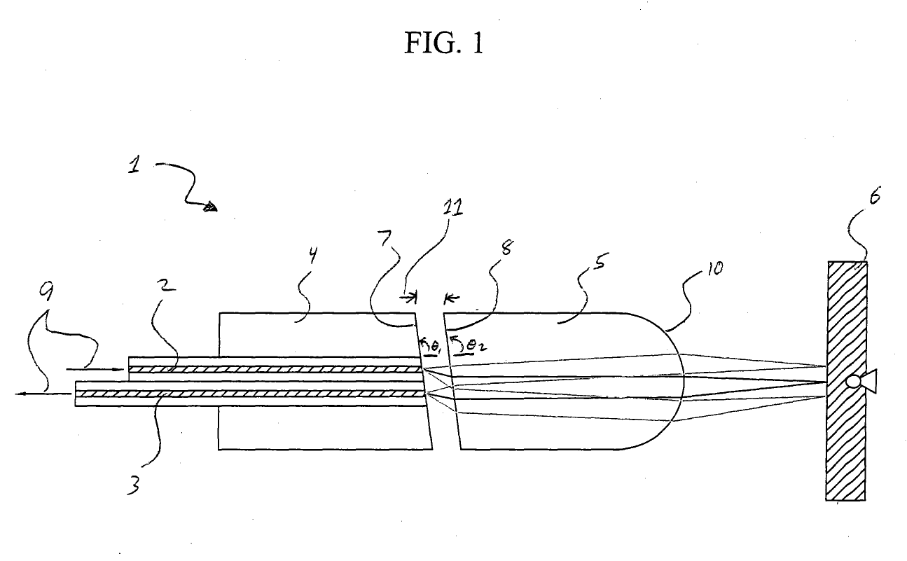

A typical VOA device of the prior art is illustrated in FIG. 1. A discussion of FIG. 1 now follows. VOA 1 comprises input optical fiber 2, output optical fiber 3, a collimator comprising ferrule 4 and lens 5, and reflective medium 6. Input fiber 2 and output fiber 3 are supported and aligned by ferrule 4. The distal portions of optical fibers 2 and 3 are planar along surface 7. Planar surface 7 is angled at θ₁ from the normal axis of the beam propagation 9. Lens 5 is aligned with the beam propagation 9 of the optical fibers 2, 3. Planar surface 8 of lens 5 is angled at θ₂ from the normal axis of beam propagation 9. In the device of the prior art θ₁=θ₂ providing that the planar surface 7 of the optical fibers is parallel to the planar surface 8 of the lens. Lens 5 further comprises a standard aspheric surface 10 in proximity to the reflecting medium 6. The distance 11 between the ferrule comprising the optical fibers and lens is typically of the order of 200 nanometers. θ₁, θ₂ are typically approximately ninety-eight degrees to minimize back reflection. It can be seen from the figure that the beam propagating from input optical fiber 2 exits optical fiber 2 at planar surface 7 and travels through the distance 11 to the planar surface 8 of lens 5. The beam then propagates through lens 5, exiting through the aspheric surface 10 of lens 5, focused onto reflective surface 6, and then returns via similar means to output optical fiber 3. The reflective surface 6 of the VOA device 1 may be a Microelectromechanical device. Such a MEM's device may comprise a 1D or 2D mirror capable of directing a beam.

The present invention comprises a method and apparatus for minimizing or reducing WDL and PDL in a combination of optical components. These beneficial results are partially achieved by altering the angle of the planar surface of the optical medium opposite the planar surface of the optical waveguides in devices such as Variable Optical Attenuators. Four primary embodiments of the relationship between planar surfaces are provided;

| | |
|---|---|
| θ₂ = 180° − θ₁, | (1) |
| θ₂ = 90°, | (2) |
| θ₂ < θ₁, | (3) |
| θ₂ ≠ θ₁, | (4) |

where θ₁ is the offset angle of the planar surface of the optical waveguides from the normal axis of beam propagation, and θ₂ is the offset angle of the planar surface of the optical medium (such as a lens) opposite the planar surface of the waveguides from the normal axis of beam propagation.

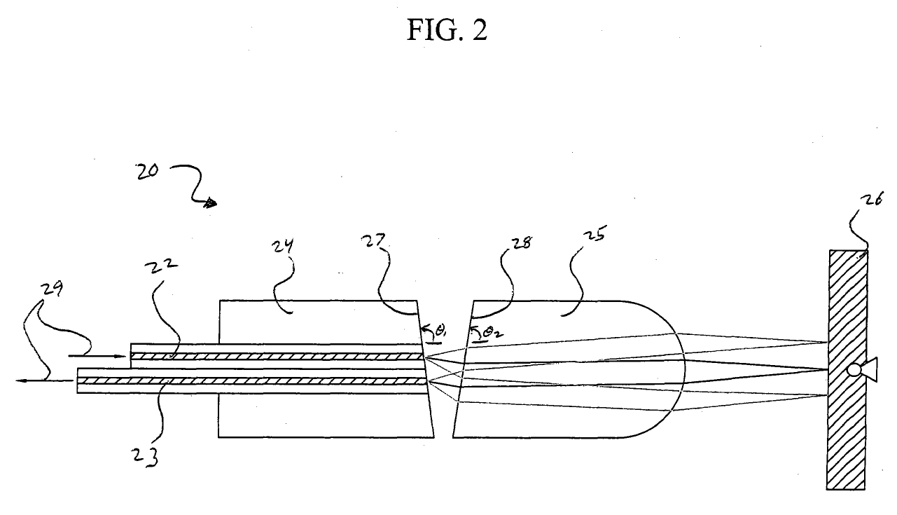

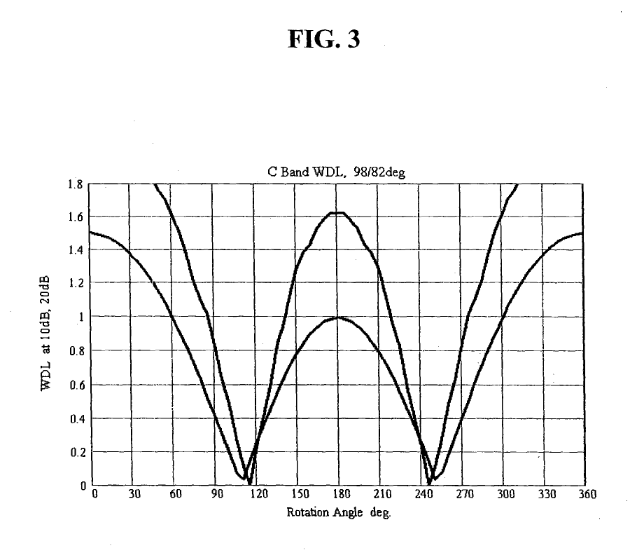

FIG. 2 is a diagram illustrating a variable optical attenuator in accordance with the present invention, where θ₂ =180° −θ₁. A discussion of FIG. 2 now follows. It will be immediately apparent to one ordinarily skilled in the art that the VOA 20 of FIG. 2 is similar to VOA 1 shown in FIG. 1. VOA 20 comprises input optical fiber 22, output optical fiber 23, and a collimator that consists of ferrule 24 and lens 25, and reflective medium 26. Input fiber 22 and output fiber 23 are supported and aligned by ferrule 24. The distal portions of optical fibers 22 and 23 are planar along surface 27. θ₁ of planar surface 27 is angled at approximately ninety-eight degrees from the normal axis of the beam propagation 29 to minimize back reflection. Lens 25 is aligned with the beam propagation 29 from the optical fibers 22, 23. θ₂ of planar surface 28 of lens 25 is angled approximately eighty-two degrees from the normal axis of beam propagation 29, or 180°−θ₁. The two planar surfaces 27 and 28 are equally offset from perpendicular to the normal axis of beam propagation as described by equation 1, where θ₂=180°−θ₁. Effectively, the lens has been rotated 180 degrees about the normal axis of beam propagation and displaced laterally with respect to the ferrule as previously illustrated in FIG. 1. One will recognize that a similar result would be achieved by rotation of the ferrule 180 degrees about the normal axis of beam propagation with respect to the lens. The altered orientation of the planar surface 28 of lens 25, which the beam from input fiber 22 propagates into and reflected beam propagates from to output fiber 23, has been shown to alter the WDL and PDL characteristics of the optical system. The graph in FIG. 3 shows the WDL characteristics of the VOA as implemented by the present invention in FIG. 2, where the WDL are measured at increasing values of attenuation of the VOA, through 360 degrees of rotation of the collimator about the tilting axis of the reflective surface. Here, the graph in FIG. 3 clearly shows minimum and maximum values of WDL through rotation about the tilting axis of the reflective surface. It is also noted that these minimum and maximum values shift through the varied attenuation positions of the VOA device, but are relatively consistent and reproducible.

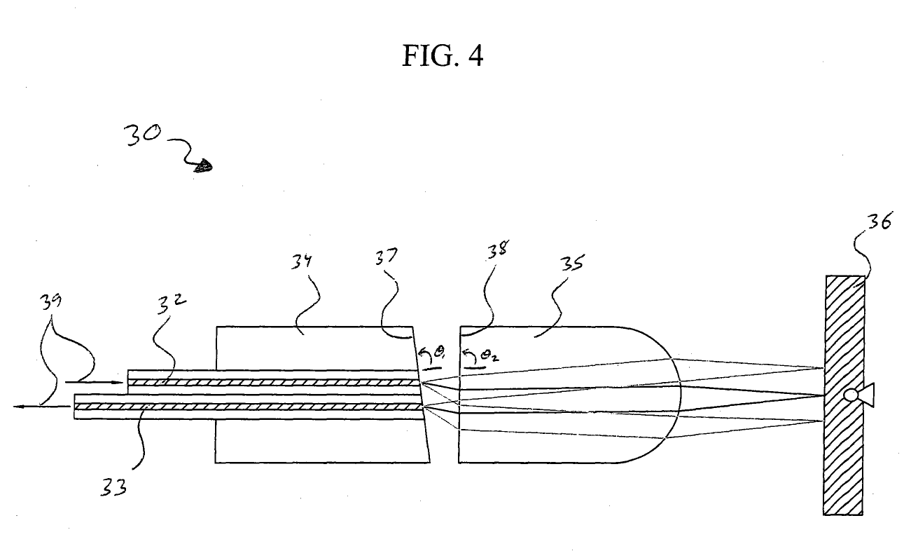

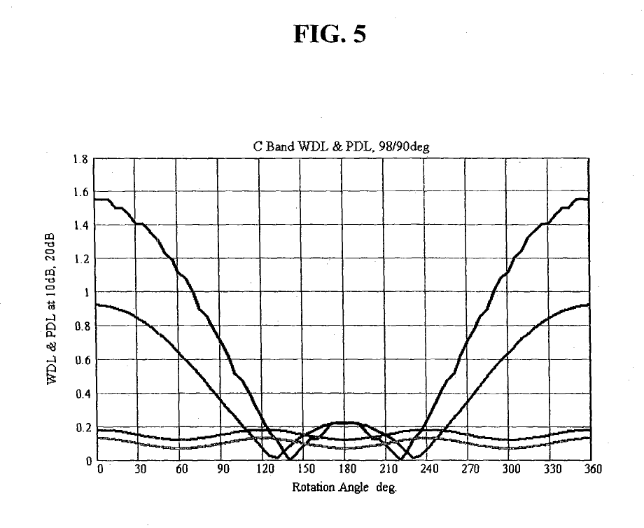

The planar face of the optical medium (lens) opposite the waveguides may also be chosen to be substantially perpendicular to the normal axis of the beam propagation as described by equation 2, where θ₂=90°. A discussion of FIG. 4 now follows. FIG. 4 illustrates VOA 30 of the present invention according to equation 2, where θ₂=90°. VOA 30 comprises input optical fiber 32, output optical fiber 33, and a collimator that consists of ferrule 34 and lens 35, and reflective medium 36. Input fiber 32 and output fiber 33 are supported and aligned by ferrule 34. The distal portions of optical fibers 32 and 33 are planar along surface 37. Planar surface 37 is angled at θ₁, approximately ninety-eight degrees from the normal axis of the beam propagation 39 to minimize back reflection. Lens 35 is aligned with the beam propagation 39 from the optical fibers 32, 33. Planar surface 38 of lens 35 is perpendicular to the normal axis of beam propagation 39, thus θ₂=90°. FIG. 5 is a graph that shows the WDL and PDL characteristics of a VOA as implemented by the present invention illustrated in FIG. 4, where the WDL and PDL are measured at increasing values of attenuation of the VOA, through 360 degrees of rotation of the collimator about the tilting axis of the reflective surface. The graph in FIG. 5 clearly shows minimum and maximum values of WDL and PDL through rotation about the tilting axis of the reflective surface. Because the planar surface of the lens of the collimator is flat, one might expect constant values of WDL and PDL through rotation about the tilting axis of the reflective surface. A portion of the varying values of WDL and PDL are likely due to inconsistent (non-homogeneous) properties of the refractive material of lens 35. In addition, the graph in FIG. 5 also shows that applying rotation about the tilting axis of the reflective surface allows for minimization of WDL and PDL in the system. It is also noted that these minimum and maximum values shift through the varied attenuation positions of the VOA device, but are relatively consistent and reproducible. Minimums and maximums for the system through varied attenuation can clearly be identified and based on orientation of the collimator be selectively chosen.

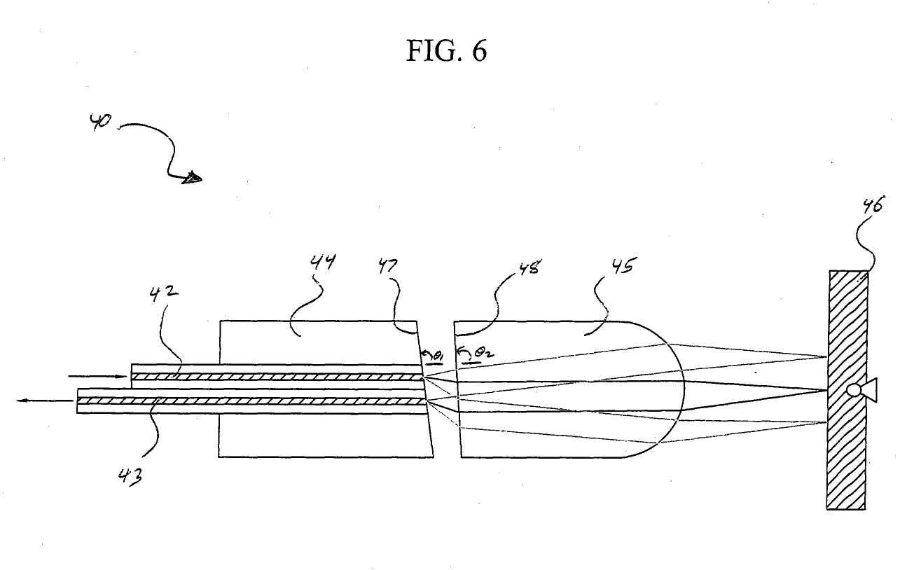

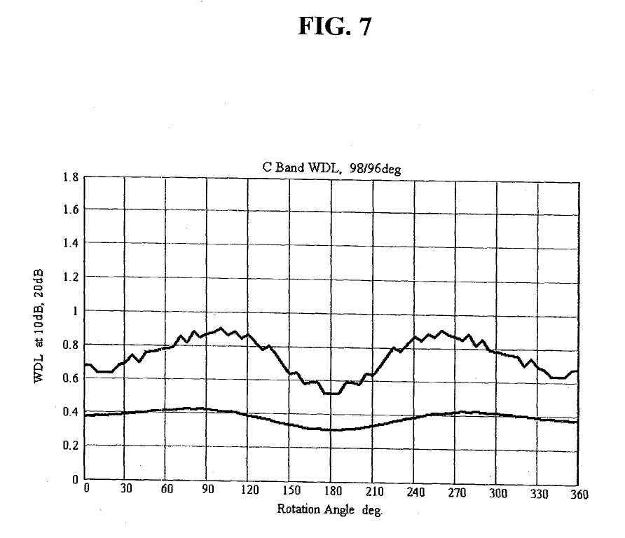

The planar face of the lens opposite the waveguides may also be chosen to be angled where θ₂<θ₁ of equation 3, or more generally where θ₂≠θ₁, of equation 4. A discussion of FIG. 6 now follows. FIG. 6 illustrates VOA 40 of the present invention according to θ₂<θ₁ of equation 3, and more generally where θ₂≠θ₁ of equation 4. VOA 40 comprises input optical fiber 42, output optical fiber 43, and a collimator that consists of ferrule 44 and lens 45, and reflective medium 46. Input fiber 42 and output fiber 43 are supported and aligned by ferrule 44. The distal portions of optical fibers 42 and 43 are planar along surface 47. Planar surface 47 is angled at θ₁ from the normal axis of the beam propagation 49. Lens 45 is aligned with the beam propagation 49 from the optical fibers 42, 43. θ₂ of planar surface 48 of lens 45 is angled such that θ₂<θ₁ from the normal axis of beam propagation 49. The graph in FIG. 7 shows the WDL characteristics of VOA as implemented by the present invention illustrated in FIG. 6, where the WDL are measured at increasing values of attenuation of the VOA, through 360 degrees of rotation of the collimator about the tilting axis of the reflective surface. The graph in FIG. 7 clearly shows minimum and maximum values of WDL through rotation about the tilting axis of the reflective surface, additionally, the graph in FIG. 7 also shows that applying rotation of the collimator about the tilting axis of the reflective surface allows for minimization of WDL in the system. Similar results are found for PDL of the VOA of FIG. 6. The results of these tests are consistent and reproducible. Minimums and maximums for the system through varied attenuation can clearly be identified and based on orientation of the collimator be selectively chosen.

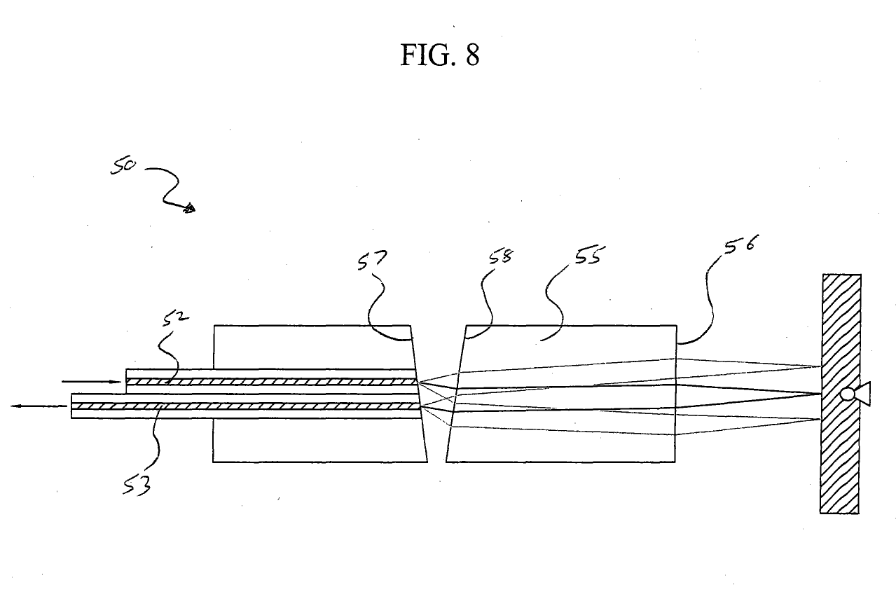

Another preferred embodiment of the present invention is provided in FIG. 8. A discussion of FIG. 8 now follows. FIG. 8 illustrates an alternate VOA device 50 having a collimator with lens 55 comprising a GRIN focusing lens 56 rather than a standard aspheric lens of prior examples. The operation of the VOA 50 is consistent with the previous examples, and the angle of planar surface 58 of lens 55 facing planar surface 57 of waveguides 52, 53, adheres to any of equations 1 through 4. Such a system continues to exhibit reproducible minimum and maximum values of WDL and PDL through varied attenuation and rotation of the collimator about the tilting axis of the reflective surface.

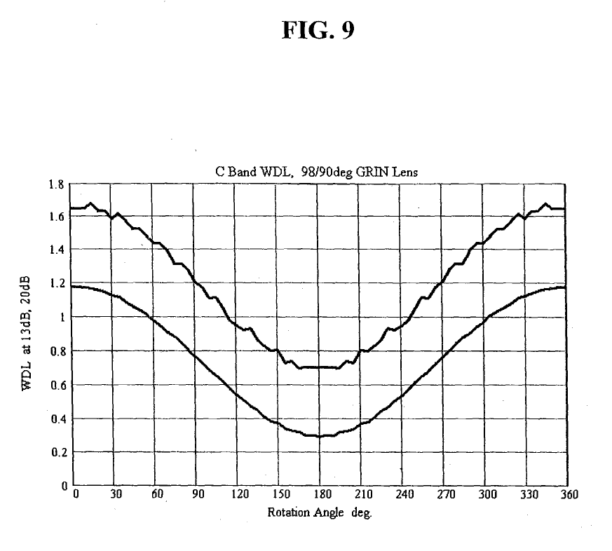

The graph in FIG. 9 shows the WDL characteristics of a VOA as implemented by the present invention illustrated by VOA 50 of FIG. 8. The graph also shows consistent results with the previously discussed VOA's comprising a collimator with aspheric lens. One skilled in the art will recognize that the optical medium of the collimator may incorporate varied focusing devices such as aspheric, regular C-lens, V-type C-lens, flat lens, GRIN-lens, ball lens, and others while continuing to benefit from the improved optical properties of the present invention. The present invention is also not limited to MEMS based VOA devices, or those incorporating only the optical components discussed herein. Additional or alternate optical components may be incorporated into the optical system or device such as prisms, additional and alternate waveguides, additional and alternate focusing devices and lenses, etc.

Although the figures associated with the preferred embodiments show the waveguides as being such that their optical axes lie in the symmetry plane of the ferrule, one skilled in the art will recognize that the waveguides need not be oriented in this manner. Instead the waveguides could be oriented such that their optical axes lie in the plane perpendicular to the symmetry plane of the ferrule and passing through the center of the ferrule. For the geometrical views provided in FIGS. 1, 2, 4, 6, and 8 only one waveguide would be visible for an embodiment in which the waveguides are aligned in the manner just described. Indeed, still more generally, the waveguides may lie on any arbitrary plane substantially containing the central axis of the ferrule.

In some preferred embodiments the waveguides are held in a single through-hole, for example surrounded by an epoxy, while in other preferred embodiments the waveguides are held in distinct individual through-holes.

Further benefits of the present invention are realized with respect to manufacture and production. Devices of the prior art, such as VOA's incorporating collimators, typically have low production yields due to misalignment of the ferrule, lens and tilting axis of the reflective medium. Axial and lateral misalignment occurs during manufacture and assembly of such devices producing devices with inconsistent and non-reproducible specifications. A feature of the present invention is that it overcomes such misalignment shortcomings and produces significantly more consistent and reproducible results—as illustrated by the incorporated graphs. Such consistency provides for higher yields, and thus lower manufacturing costs and increased production volume. Ease of manufacture is also simplified, as the preferred orientation of ferrule and lens of the collimator is well determined.

It is the intention of the previously described invention is to provide a method and apparatus of combined optical components having improved optical characteristics, reduced wavelength dependent loss, reduced polarization dependent loss, and improved manufacturing and production characteristics.

What is claimed is:

1. An improved variable optical attenuator (VOA) comprising a VOA package, a movable optical component with a reflecting surface, and a collimator, wherein the collimator is such that the geometry and relative position and orientation of the optical components of which the collimator is comprised are selected to provide minimal wavelength-dependent optical losses.

2. A VOA providing minimal wavelength-dependent optical losses as recited in claim 1, wherein the collimator comprises:
at least one first waveguide having an end and capable of emitting polychromatic light from this end;
at least one second waveguide having an end and capable of receiving polychromatic light at this end;
a housing mounted to the VOA package;
a ferrule mounted in the housing and having at least one through-hole extending through its length, the ferrule through-hole(s) containing a portion of the first and second waveguides, and the ends of the waveguides and the end of the ferrule all occupying a first plane of the ferrule, this first plane not perpendicular to the central axis of the ferrule;
at least one lens for collimating and focusing polychromatic light, the lens having a first end and a second end, the first end being planar, and the lens mounted in the housing such that:
the first end of the lens faces the first plane of the ferrule;
the second end of the lens faces the reflecting surface of the movable component within the VOA package;
the plane of the first end of the lens is not parallel to the first plane of the ferrule;
polychromatic light emitted from the end of the first waveguide passes through the lens and is reflected by the movable component back through the lens with at least a portion of the light received by the end of the second waveguide; and
the axial orientation of the plane of the first end of the lens with respect to the ends of the waveguides and end of the ferrule is selected so as to minimize wavelength-dependent optical losses.

3. A VOA as recited in claim 2, wherein the first plane of the ferrule is oriented at an angle with respect to the optical axis of the lens and the first end of the lens is perpendicular to its optical axis.

4. A VOA as recited in claim 2, wherein the ferrule and the lens are such that:
the symmetry planes of both are coincident;
the first plane of the ferrule is perpendicular to the symmetry plane and the angle between the first plane and planes perpendicular to the central axis of the ferrule is θ₁;
the plane of the first end of the lens is perpendicular to the symmetry plane and
the angle between the plane of the first end of the lens and planes perpendicular to the optical axis of the lens is also θ₁; and
the first plane of the ferrule and the first end of the lens are not parallel.

5. A VOA as recited in claim 2, wherein the movable optical component tilts about at least one axis.

6. A VOA as recited in claim 2, wherein the movable optical component tilts about at least two axes.

7. A VOA as recited in claim 6, wherein the movable optical component additionally moves translationally in at the axial direction.

8. A VOA as recited in claim 2, wherein the movable optical component is a MEMS structure.

9. A VOA as recited in claim 2, wherein the at least one first and second waveguides are optical fibers.

10. A VOA as recited in claim 9, wherein the first and second waveguides are substantially parallel and close together and occupy a single through-hole in the ferrule.

11. A VOA as recited in claim 9, wherein the first and second waveguides are substantially parallel and close together and occupy distinct through-holes in the ferrule.

12. A VOA as recited in claim 2, wherein the optical axes of the first and second waveguides are in the symmetry plane of the ferrule, this plane defined as the unique plane about which the geometry of the ferrule is symmetric.

13. A VOA as recited in claim 2, wherein the ferrule and waveguides are such that the optical axes of the first and second waveguides are in the unique plane containing the central axis of the ferrule and perpendicular to the symmetry plane of the ferrule, this symmetry plane defined as the unique plane about which the geometry of the ferrule is symmetric.

14. A method for constructing a variable optical attenuator (VOA) which minimizes wavelength-dependent optical losses, the method comprising the following steps:
(1) providing a movable optical component with a reflecting surface;
(2) providing a collimator with an input waveguide, an output waveguide, a ferrule holding a portion of the waveguides, a lens, and a housing, wherein the geometry and relative position and axial orientation of the optical components of which the collimator is comprised has been selected so as to provide minimal wavelength-dependent optical losses;
(3) positioning and aligning the movable optical component and the collimator in a package so that light entering the input waveguide and leaving the collimator is reflected from the movable optical component back through the lens of the collimator in such a way that at least a portion of the reflected light enters the output waveguide with minimal wavelength-dependent losses; and
(4) mounting the movable optical component and the collimator in the package in the aforesaid position and alignment.

15. A method for constructing a VOA which minimizes wavelength-dependent optical losses as recited in claim 14, wherein the collimator geometry is optimized in step (2) by the following steps:
(a) providing a housing;
(b) providing a ferrule which is such that the end of the ferrule and the ends of the waveguides it holds occupy a first plane and the angle of orientation of this first plane with respect to the central axis of the ferrule is θ₁≠90 degrees;
(c) providing a lens having a first end and a second end which is such that the first end of the lens is planar, and the angle of orientation of this end of the lens with respect to the optical axis of the lens is θ₂;
(d) mounting a first component to the housing, the first component being the ferrule or the lens;
(e) placing a second component in the housing, the second component being the ferrule or lens and not the first component, and the placing of this second component such that it is free to rotate about its central axis;
(f) positioning a temporary movable optical component with a reflecting surface such that the reflecting surface faces the second end of the lens, this temporary movable optical component not necessarily being the movable optical component of the VOA;
(g) transmitting polychromatic light into the input waveguide such that the light leaves the end of the input waveguide, passes through and is collimated by the lens, is reflected by the reflecting surface of the temporary movable optical component back through the lens, is focused by the lens onto the end of the output waveguide so that at least a portion of the light enters the output waveguide;
(h) rotating the second component (see (e)) about the optical axis until an optimal axial orientation is determined, the optimal orientation being an orientation that, in combination with the geometries and relative position of the ferrule and the lens, is such that WDL is minimized; and
(i) mounting the second component to the housing in the optimal axial orientation determined in (h), thereby completing assembly of a WDL-optimized collimator.

16. A method for constructing a VOA as recited in claim 15, wherein the lens is such that its first end is perpendicular to its optical axis.

17. A method for constructing a VOA as recited in claim 15, wherein the ferrule and the lens are such that:
the symmetry planes of both are coincident;
the first plane of the ferrule is perpendicular to the symmetry plane and the angle between the first plane and planes perpendicular to the central axis of the ferrule is θ₁;
the plane of the first end of the lens is perpendicular to the symmetry plane and
the angle between the plane of the first end of the lens and planes perpendicular to the optical axis of the lens is also θ₁; and
the first plane of the ferrule and the first end of the lens are not parallel.

18. A method for constructing a VOA as recited in claim 15, wherein the movable optical component tilts about at least one axis.

19. A method for constructing a VOA as recited in claim 15, wherein the movable optical component tilts about at least two axes.

20. A method for constructing a VOA as recited in claim 19, wherein the movable optical component additionally moves translationally in at the axial direction.

21. A method for constructing a VOA as recited in claim 15, wherein the movable optical component is a MEMS structure.

22. A method for constructing a VOA as recited in claim 15, wherein the at least one first and second waveguides are optical fibers.

23. A method for constructing a VOA as recited in claim 22, wherein the first and second waveguides are substantially parallel and close together and occupy a single through-hole in the ferrule.

24. A method for constructing a VOA as recited in claim 22, wherein the first and second waveguides held by the ferrule are substantially parallel and close together and occupy distinct through-holes in the ferrule.

25. A method for constructing a VOA as recited in claim 15, wherein the optical axes of the first and second waveguides are in the symmetry plane of the ferrule, this plane defined as the unique plane about which the geometry of the ferrule is symmetric.

26. A method for constructing a VOA as recited in claim 15, wherein the ferrule and waveguides are such that the optical axes of the first and second waveguides are in the unique plane containing the central axis of the ferrule and perpendicular to the symmetry plane of the ferrule, this symmetry plane defined as the unique plane about which the geometry of the ferrule is symmetric.
